(19) United States
(12) Patent Application Publication
(10) Pub. No.: US 2014/0317411 A1
(43) Pub. Date: Oct. 23, 2014

(54) DEDUPLICATION OF DATA

(71) Applicant: Intronis, Inc., Chelmsford, MA (US)

(72) Inventors: Steven Frank, Maynard, MA (US); Alex Kiryanov, Attleboro, MA (US)

(73) Assignee: Intronis, Inc., Chelmsford, MA (US)

(21) Appl. No.: 14/256,348

(22) Filed: Apr. 18, 2014

Related U.S. Application Data
(60) Provisional application No. 61/813,253, filed on Apr. 18, 2013.

(51) Int. Cl. G06F 3/06

(52) U.S. Cl. CPC G06F 3/0641; G06F 3/067; G06F 3/0619
USPC 713/171; 707/654

(57) ABSTRACT

Backing up a data file can be accomplished by processing, in-line and at a first client, a plurality of datablocks taken from the data file. The processing of each datablock includes creating a unique signature of the datablock and determining whether the signature is contained in a database of signatures. Each signature in the database is associated with previously backed up datablocks. The database of signatures includes signatures of previous backed up datablocks that were backed up from at least one other client. Data are transmitted to a remote backup server for backing up the datablock. The transmitted data characterize a link to one of the previously stored datablocks when the signature of the processed datablock is found in the database of signatures. Related apparatus, systems, techniques, and articles are also described.

### CROSS-REFERENCE TO RELATED APPLICATIONS

This application claims the benefit of U.S. Provisional Patent Application Ser. No. 61/813,253 filed on Apr. 18, 2013, the contents of which are hereby incorporated by reference in their entirety.

### TECHNICAL FIELD

The subject matter described herein relates to remote backup of data files, and more specifically, to data deduplication of large files undergoing remote backup.

### BACKGROUND

Backups have multiple purposes. One purpose is to recover data after loss, be it by data deletion or corruption. Data loss can be a common experience of computer users. Another purpose of backups is to recover data from an earlier time, according to a user-defined data retention policy, typically configured within a backup application for how long copies of data are required. Backups represent a simple form of disaster recovery, and should be part of a disaster recovery plan.

Since a backup system contains at least one copy of all data worth saving, the data storage requirements can be significant. Organizing this storage space and managing the backup process can be a complicated undertaking A data repository model can be used to provide structure to the storage. There are many different types of data storage devices that are useful for making backups. There are also many different ways in which these devices can be arranged to provide geographic redundancy, data security, and portability.

Before data are sent to a storage location, the data can be selected, extracted, and manipulated. Many different techniques can be used to optimize the backup procedure. These include optimizations for dealing with open files and live data sources as well as compression, and encryption, among others.

### SUMMARY

In a first aspect, backing up a data file can be accomplished by processing, in-line and at a first client, multiple datablocks taken from the data file. The processing of each datablock includes creating a unique signature of the datablock; and determining whether the unique signature is contained in a database of signatures, in which database each signature is associated with previously backed up datablocks. The database includes signatures of previous backed up datablocks that were backed up from at least one other client. Data are transmitted to a remote backup server for backing up the datablock. The transmitted data characterize a link to one of the previously stored datablocks when the signature of the processed datablock is found in the database of signatures. The transmitted data characterize a copy of the processed datablock when the signature of the processed datablock is not contained in the database of signatures.

One or more of the following features can be included. For example, the database of signatures can include multiple entries for a single unique signature of previously backed up datablocks. The entire state of the first client can be stored in the data file. The first client and the at least one other client can be servers. Each datablock size can be 32 megabytes. The data file is can be a VMware file. The data file can be a large file relative to datablock size. The processing of each datablock can further include transmitting data to the at least one other client, the data characterizing the unique signature of the processed datablock to update each of the at least one other client's database of signatures. The transmitted data can be encrypted prior to transmission. The encryption key used by the first client can be known by the at least one other client, and the encryption key can be used by the at least one other client to perform datablock backups. The unique signature can be a hash of a predefined portion of the processed datablock.

Computer program products are also described that comprise non-transitory computer readable media storing instructions, which when executed by at least one data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. The subject matter described herein provides many advantages. Data deduplication causes a remote backup of many clients, each client containing many data files, to determine unique blocks of data that repeat among all the data files and store only one copy of each block of data. This reduces the backup storage capacity requirements, network data transmission loads, and processing requirements.

A second aspect of the present invention includes a system for backing up a data file via a communication network. The system can include a remote backup server that is in communication with the communication network, and multiple clients that are in communication with the communication network. In some variations, each client includes a first database or memory containing executable machine instructions, a database of signatures, and a programmable processing device that is adapted to execute machine instructions that can include processing, in-line and at a first client, datablocks taken from the data file. In some implementation, the processing of each datablock can include creating a unique signature of the datablock, determining whether the created unique signature is contained in a database of signatures, each signature in the database associated with previously backed up datablocks and the database including signatures of previous backed up datablocks that were backed up from another client(s), and transmitting data to a remote backup server for backing up the datablock. The transmitted data characterize a link to one of the previously stored datablocks when the created unique signature of the processed datablock is found in the database of signatures. The transmitted data characterize a copy of the processed datablock when the created unique signature of the processed datablock is not contained in the database of signatures.

One or more of the following features can be included. For example, the database of signatures can include multiple entries for a single unique signature of previously backed up datablocks. The entire state of the first client can be stored in the data file. The first client and the at least one other client can be servers. Each datablock size can be 32 megabytes. The data file is can be a VMware file. The data file can be a large file relative to datablock size. The processing of each datablock can further include transmitting data to the at least one other client, the data characterizing the unique signature of the processed datablock to update each of the at least one other client's database of signatures. The system can further include an encryption device that is adapted to encrypt the transmitted data prior to transmission. In some implementations, an encryption key used by the first client is known by another client(s), and the encryption key is used by another client(s) to perform datablock backups.

A third aspect includes an article of manufacture for backing up a data file. In some embodiments of the third aspect, the article of manufacture includes machine readable instructions that include processing, in-line and at a first client, multiple datablocks taken from the data file. In some variations, the processing of each datablock can include creating a unique signature of the datablock; determining whether the created unique signature is contained in a database of signatures, each signature in the database associated with previously backed up datablocks. The database can include signatures of previous backed up datablocks that were backed up from another client(s); and transmitting data to a remote backup server for backing up the datablock. The transmitted data characterize a link to one of the previously stored datablocks when the created unique signature of the processed datablock is found in the database of signatures. The transmitted data characterize a copy of the processed datablock when the created unique signature of the processed datablock is not contained in the database of signatures.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a process flow diagram of an illustrative embodiment of a method of backing up a data file; and

FIG. 2 shows a diagram of an illustrative embodiment of a remote backup system for backing up data files and for removing redundancies from the data.

### DETAILED DESCRIPTION

Data deduplication is a technique of removing redundancies from data. Data deduplication in remote backup systems can provide a number of advantages. For example, data deduplication can be used to inspect large volumes of data and identify large sections (such as entire files or large sections of files) that are identical in order to store only one copy of the large sections. Data deduplication can also be applied to network data transfers to reduce the volume of data that must be sent. In the deduplication process, unique datablocks, or bit patterns, are identified. Other (e.g., previously stored) datablocks are then compared to the identified datablocks to determine if the identified datablocks are identical to the stored datablock. Whenever a match occurs, the redundant identified datablock is replaced with a link or reference that points to the previously stored datablock. Given that the same pattern (i.e., datablock) can occur many times, the amount of data that must be stored and/or transferred can be greatly reduced.

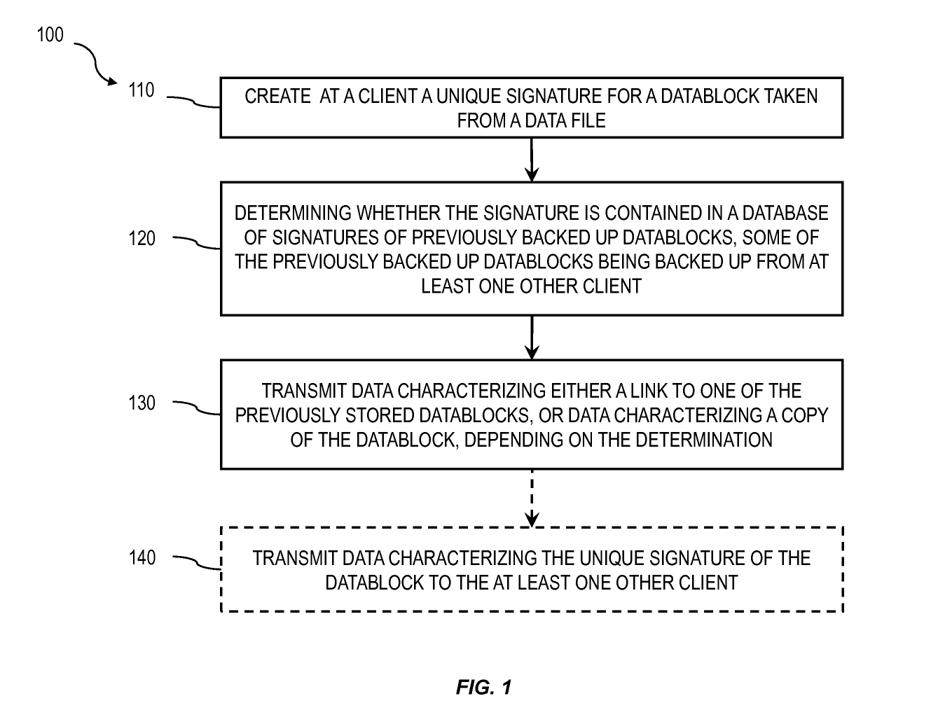

FIG. 1 is a process flow diagram 100 for an illustrative method of data deduplication in accordance with some embodiments of the present invention. The method includes the processing of a plurality of datablocks taken from a data file. The processing is performed in-line, that is, the processing removes redundancies from datablocks before or as the datablock writes to a backup device (i.e., backed up). In-line processing is in contrast to post-processing, wherein the processing removes redundancies in the datablock after the datablock writes to the backup device. In-line processing reduces the amount of redundant data that is transmitted across a network during remote backup. This improves efficiency.

Datablocks are blocks or chunks of data taken from the data file. For example, a datablock could consist of contiguous bits, such as bits 1 to N as measured from the beginning of the file. A second datablock could consist of the N+1 to 2*N bits of data (measured from the beginning of the file), and so on.

For each datablock taken from a data file, at 110, a unique signature of the datablock is created. The unique signature is a unique descriptor of the datablock and can include data related to, including, or derived from the datablock. For example, a signature can be calculated by appending the first and last bytes of the datablock with a SHA1 hash of the data in the datablock. Other signature schemes are possible. Signature schemes can be designed to reduce the likelihood of a collision between two datablock signatures.

At 120, it is determined whether the created unique signature is contained within a database of signatures of previously backed up datablocks. Some of the previously backed up datablocks have been backed up from one or more other clients. The database of signatures is located at the first client.

At 130, in the case where the signature is already contained within the signature database of previously backed up datablocks, data are transmitted characterizing a link to one of the previously stored datablocks. In the case where the signature is not contained within the signature database of previously backed up datablocks, data are transmitted characterizing a copy of the datablock. The data can be transmitted to a remote backup server for storage.

Optionally, at 140, data characterizing the signature of the datablock being processed can be transmitted to the one or more other clients. The signature can be added to signature databases located at each of the one or more other clients. Since data deduplication can be performed in parallel across multiple clients, it is possible that the signature databases contain multiple entries for the same unique datablock. In other words, it is possible that the same unique datablock is backed up more than once. Such duplication of datablocks is rare in practice and the loss of efficiency is acceptable.

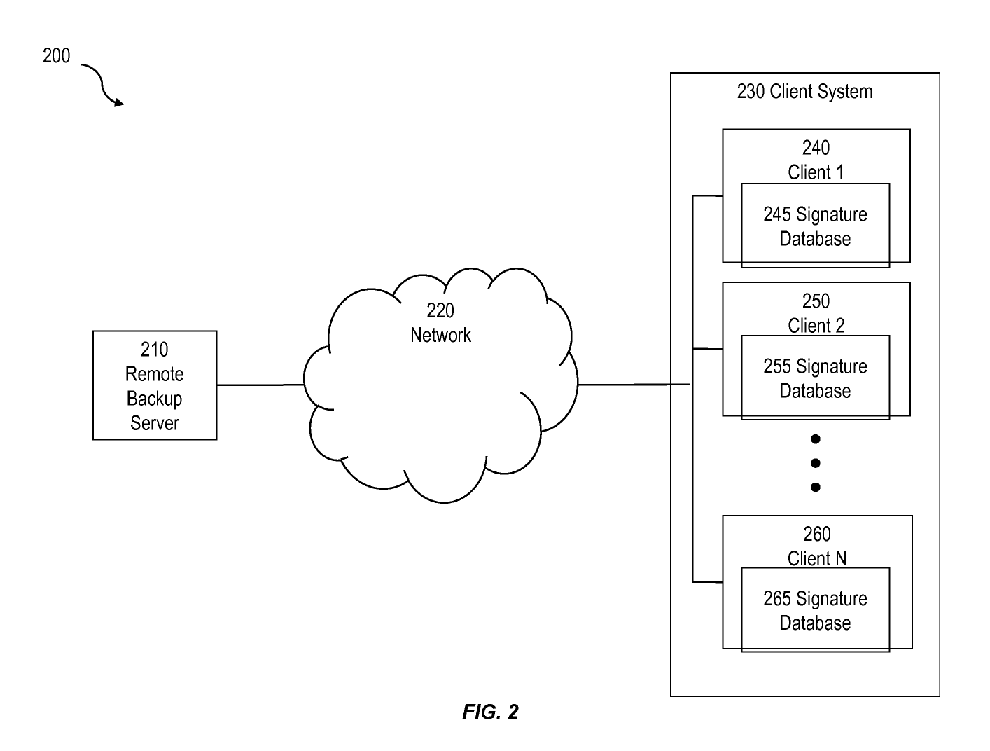

FIG. 2 is a diagram illustrating a remote backup system 200 for backing up data files that removes redundancies from the data in accordance with some embodiments of the present invention. The remote backup system 200 includes a remote backup server 210 for storage of data. The remote backup server 210 is connected through a communication network 220 to a client system 230. The client system 230 can include a plurality of clients (e.g., client 240, client 250, client 260, etc.), each client having a signature database (e.g., 245, 255, 265). The client system 230 can be a network of local clients 240, 250, 260 associated with one another. For example, the client system 230 could comprise computing devices on a network of a medium or small business, such as a doctor's office. Each client 240, 250, 260 could be a server, workstation, mobile computing device, etc.

The signature databases 245, 255, and 265 generally contain the signatures of previously backed up datablocks of data, regardless of whether the data were backed up from the client 240, 250, 260 on which the particular signature database 245, 255, 265, respectively, resides.

When combined with remote backup, data deduplication can occur independently for each client 240, 250, 260. Data transmitted across a network can be encrypted for security. This encryption can prevent, for identical underlying data, an accurate comparison between two datablocks. This causes a remote backup system to store redundant data. However, when the clients share security features, this redundancy can be reduced. Therefore, each client 240, 250, 260 can share security features such as sharing an encryption key.

Data deduplication can be used to inspect large volumes of data. The large volumes of data can include images of the client such that the entire state of the client is stored in the data file. For example, VMware image files store the state of a computing system.

Choosing a correct datablock size can be important. There is a greater chance that datablocks will be redundant when datablock size is small thus improving storage efficiency. On the other hand, larger datablock sizes require less processing, with less complex management and maintenance of the signature databases. In general, to realize improved efficiency, the data file should be a large file relative to the datablock size. One suitable datablock size can be 32 Megabytes for deduplication data files that are greater than 64 Megabytes.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well. For example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A computer-implemented method of backing up a data file, the method comprising:
processing, in-line and at a first client, a plurality of datablocks taken from the data file, the processing of each datablock comprising:
creating a unique signature of the datablock;
determining whether the created unique signature is contained in a database of signatures, each signature in the database associated with previously backed up datablocks, the database including signatures of previous backed up datablocks that were backed up from at least one other client; and
transmitting data to a remote backup server for backing up the datablock, wherein the transmitted data characterize a link to one of the previously stored datablocks when the created unique signature of the processed datablock is found in the database of signatures and wherein the transmitted data characterize a copy of the processed datablock when the created unique signature of the processed datablock is not contained in the database of signatures.

2. The computer-implemented method of claim 1, wherein the database of signatures includes multiple entries for a single unique signature of previously backed up datablocks.

3. The computer-implemented method of claim 1, wherein an entire state of the first client is stored in the data file.

4. The computer-implemented method of claim 1, wherein the first client and the at least one other client are servers.

5. The computer-implemented method of claim 1, wherein each datablock size is 32 megabytes.

6. The computer-implemented method of claim 1, wherein the data file is a VMware file.

7. The computer-implemented method of claim 1, wherein the data file is a large file relative to datablock size.

8. The computer-implemented method of claim 1, wherein the processing of each datablock further comprises:
transmitting data to the at least one other client, the data characterizing the unique signature of the processed datablock to update each of the at least one other client's database of signatures.

9. The computer-implemented method of claim 1, wherein the transmitted data is encrypted prior to transmission.

10. The computer-implemented method of claim 9, wherein an encryption key used by the first client is known by the at least one other client, and the encryption key is used by the at least one other client to perform datablock backups.

11. The computer-implemented method of claim 1, wherein the unique signature is a hash of a predefined portion of the processed datablock.

12. A system for backing up a data file via a communication network, the system comprising:
a remote backup server that is in communication with the communication network;
a plurality of clients that is in communication with the communication network, each client of the plurality of clients including:
memory containing executable machine instructions;
a database of signatures; and
a programmable processing device that is adapted to execute machine instructions that comprise processing, in-line and at a first client, a plurality of datablocks taken from the data file, the processing of each datablock comprising:
creating a unique signature of the datablock,
determining whether the created unique signature is contained in a database of signatures, each signature in the database of signatures associated with previously backed up datablocks, the database including signatures of previous backed up datablocks that were backed up from at least one other client, and
transmitting data to a remote backup server for backing up the datablock, wherein the transmitted data characterize a link to one of the previously stored datablocks when the created unique signature of the processed datablock is found in the database of signatures and wherein the transmitted data characterize a copy of the processed datablock when the created unique signature of the processed datablock is not contained in the database of signatures.

13. The system of claim 12, wherein the database of signatures includes multiple entries for a single unique signature of previously backed up datablocks.

14. The system of claim 12, wherein an entire state of the first client is stored in the data file.

15. The system of claim 12, wherein the first client and the at least one other client are servers.

16. The system of claim 12, wherein the programmable processing device is adapted to execute machine instructions that further comprise transmitting data to the at least one other client, the data characterizing the unique signature of the processed datablock to update each of the at least one other client's database of signatures.

17. The system of claim 12 further comprising an encryption device that is adapted to encrypt the transmitted data prior to transmission.

18. The system of claim 17, wherein an encryption key used by the first client is known by the at least one other client, and the encryption key is used by the at least one other client to perform datablock backups.

19. An article of manufacture for backing up a data file, the article of manufacture including machine readable instructions comprising:
processing, in-line and at a first client, a plurality of datablocks taken from the data file, the processing of each datablock comprising:
creating a unique signature of the datablock;
determining whether the created unique signature is contained in a database of signatures, each signature in the database of signatures associated with previously backed up datablocks, the database including signatures of previous backed up datablocks that were backed up from at least one other client; and
transmitting data to a remote backup server for backing up the datablock, wherein the transmitted data characterize a link to one of the previously stored datablocks when the created unique signature of the processed datablock is found in the database of signatures and wherein the transmitted data characterize a copy of the processed datablock when the created unique signature of the processed datablock is not contained in the database of signatures.
